(19) United States
(12) Patent Application Publication
(10) Pub. No.: US 2014/0214641 A1
(43) Pub. Date: Jul. 31, 2014

(54) Electronic Receipt Including Itemization Of Applicable Tax Rates

(71) Applicant: WAL-MART STORES, INC., Bentonville, AR (US)

(72) Inventors: Joel Bennett Acker, JR., Brush Prairie, WA (US); Richard Neil Cancro, Portland, OR (US); Douglas James Pedley, Portland, OR (US)

(73) Assignee: Wal-Mart Stores, Inc., Bentonville, AR (US)

(21) Appl. No.: 13/753,421

(22) Filed: Jan. 29, 2013

(51) Int. Cl. G06Q 40/00

(52) U.S. Cl. CPC G06Q 40/00
USPC 705/35

(57) ABSTRACT

A method providing an electronic receipt to a user includes obtaining the electronic receipt corresponding to the user at a processing device of a tax itemization server. The electronic receipt indicating one or more purchased items, each purchased item indicating a purchased product from a facility of the retailer. A classification of each of the one or more purchased items and a tax jurisdiction of the facility are extracted from the electronic receipt. For the classification of each purchased item that is mandated as being taxable by the tax jurisdiction, an itemization of one or more tax rates applicable to the classification of the purchased item that are imposed by the tax jurisdiction is obtained. The electronic receipt including the itemization of one or more tax rates applicable to each classification of each purchased item that is mandated as being taxable is provided to the user.

### BACKGROUND INFORMATION

1. Field of the Disclosure

The present invention relates generally to systems and methods for providing electronic receipts to a user indicating one or more purchased items by the user. In particular, examples of the present invention are related to techniques for retrieving one or more tax rates applicable to a classification of a purchased item and generating an itemization of the one or more tax rates applicable to each classification of each purchased item that is mandated as being taxable.

2. Background

When a customer purchases products from a facility of a retailer, the customer is provided a receipt of the transaction at a point-of-sale. The receipt generally includes an itemization of each purchased product and a respective net or retail cost of each purchased product. A total net cost of all the products purchased by the customer is presented on the receipt. An aggregate sales tax incurred by the customer is additionally presented on the receipt. A gross cost presented on the receipt includes the sum of the total net cost and the aggregate tax incurred by the customer, wherein the gross cost is indicative of the true cost that the customer was charged for the transaction.

One drawback of simply presenting the aggregate sales tax on the receipt is that the customer is not aware of how the sales tax is computed, to which items the sales tax applies, and how the sales tax is being allocated to one or more governing bodies imposing the sales tax. For instance, a customer will indefinitely incur a higher aggregate sales tax when purchasing products in Chicago, Ill. than the customer would for purchasing the same products in Aurora, Ill. due to Chicago-specific local sales tax rates applied in addition to the Illinois sales tax rate. In another instance, purchased beer may appear to have an unreasonably high cost compared to other geographical locations due to the retailer inflating the retail cost of the beer to recover an excise tax imposed by a tax jurisdiction on beer. In this instance, the excise tax is hidden from the customer.

Further, certain classifications of items are exempt from being taxed while other classifications are taxable. Likewise, some classifications of items may have higher tax rates than other classifications. Hence, the total sales tax incurred by the customer is based on many factors that may be desirable to itemize so that the customer is aware of why they are being taxed and to what governing bodies, e.g., tax jurisdictions, the paid taxes are going. Accordingly, a customer can be made aware of how legislation affects their monies.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 schematically illustrates a tax itemization server in communication with a facility computing device and a user computing device, in accordance with an exemplary embodiment of the present disclosure;

FIGS. 2A-2D schematically illustrate non-limiting examples of electronic receipts including a generated itemization of one or more tax rates applicable to each classification of each purchased item mandated as taxable and provided to the user computing device of FIG. 1, in accordance with an exemplary embodiment of the present disclosure;

FIG. 3 is a block diagram illustrating components of the facility computing device of FIG. 1, in accordance with the present disclosure

FIG. 4 is a block diagram illustrating components of the tax itemization server of FIG. 1, in accordance with an exemplary embodiment of the present disclosure;

FIG. 5 is a block diagram illustrating components of the user computing device of FIG. 1, in accordance with an exemplary embodiment of the present disclosure; and

FIG. 6 is a flowchart illustrating an example method for providing an electronic receipt to a user including a generated itemization of one or more tax rates applicable to each classification of each purchased item that is mandated as being taxable, in accordance with an exemplary embodiment of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. Techniques for obtaining an itemization of one or more tax rates applicable to a classification of a purchased item that are imposed by a tax jurisdiction are described herein. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

It may be desirable to provide a user with an electronic receipt that includes all tax rates applied to products purchased by the user from a facility of a retailer. As used herein, the term “electronic receipt” can refer to one or more purchased items, each purchased item indicating a purchased product from a facility of the retailer. Electronic receipts can be received by a tax itemization server from any suitable source. In some embodiments, the electronic receipt can be provided from the facility of the retailer at a point of sale. For example, a user may provide a user identifier by swiping an ID card or entering an email address/username/password at the point of sale when purchasing products. The electronic receipt can then be provided to a user computing device corresponding to the user using the user identifier. As used herein, the term “tax rate” can refer to any tax rate imposed by a tax jurisdiction on a classification of a purchased item. The tax rate can include a sales tax rate indicative of a non-zero integer (e.g., percentage) applied to a net cost of the purchased product and/or the tax rate can include an excise tax rate indicative of a non-zero integer (e.g., dollar amount) applied to a unit of the purchased product. Excise tax rates are conventionally imposed by the tax jurisdiction directly upon the retailer, wherein the retailer inflates the retail cost (e.g., net cost) of the item to cover the excise tax incurred by the retailer. For instance, the tax jurisdiction may impose a $0.33 rate per gallon (i.e., unit) of beer sold by the retailer. This excise tax rate would be hidden from the customer as the net cost is simply inflated to cover the cost paid by the retailer.

As used herein, the term “facility” can refer to shopping venues, complexes and department stores, wherein a “facility attendant” can refer to one or more individuals, managers, stock persons, inventory personal, cashiers, or greeters employed by the retailer at a specific facility and on duty. As used herein, the term “item” can refer to any type of indicator of a product sold by a retailer and the term “product” can refer to groceries, foods, prepared foods, office supplies, clothing wares, or any other fungible goods sold by a retailer.

Conventionally, receipts or electronic receipts do not include all tax rates applicable to a classification of the purchased item, but rather include an aggregate tax incurred by the customer for all products purchased without the customer knowing which items are taxable, what rates are applied to the items that are taxable, and to what tax jurisdiction(s) the incurred taxes are provided to. As used herein, the term “classification” can refer to any type of indicator of an item that the tax jurisdiction mandates as being taxable (or being exempt from taxation), and accordingly imposes a tax rate. Accordingly, the classification of a purchased item may be selected from the group consisting of: groceries, prepared food, prescription medication, non-prescription medication, clothing, agricultural, alcohol/tobacco, soft drinks and generally taxed items. As used herein, the term “tax jurisdiction” can refer to any governing body having taxation authority to mandate classifications of purchased items as being taxable. The tax jurisdiction having taxation authority is determined by a geographical location of a facility of a retailer offering the item. Accordingly, the tax jurisdiction can include a country, state, province, country or municipality. In some embodiments, the tax jurisdiction can include a constituent tax jurisdiction of one or more principle tax jurisdictions also mandating the classification as taxable. In this scenario, each of the constituent tax jurisdiction and the one or more principle tax jurisdictions impose at least one respective tax rate applicable to the classification. The tax rate imposed by the constituent tax jurisdiction can be referred to as a home rule or local tax rate and the tax rate imposed by the principle tax jurisdiction can be referred to as a general tax rate. For instance, for an item classified as clothing purchased in Chicago, a 3% sales tax rate for the clothing would be imposed by the city of Chicago in addition to a 6.5% sales tax rate for the clothing imposed by the state of Illinois. In some embodiments, the classification of the item can have more than one applicable tax rate. For instance, a soft drink purchased from a facility deli may be subject to a soft drink sales tax rate in addition to a general sales tax rate for purchasing prepared food within a tax jurisdiction, e.g., a state. In this scenario, the customer may only be aware of an aggregate sales tax rate including the soft drink sales tax rate and the general sales tax rate without knowing two separate and distinct sales tax rates are incurred by the customer.

Embodiments are directed toward obtaining an itemization of one or more tax rates applicable to a classification of a purchased item that are imposed by a tax jurisdiction and providing an electronic receipt including the itemization of the one or more tax rates to a user. The itemization of the one or more tax rates is based on a classification of the purchased item and the tax jurisdiction of the facility. The classification of each purchased item and the tax jurisdiction may be extracted from an electronic receipt corresponding to the user. For instance, the electronic receipt may be received at a point of sale from a facility computing device furnished within the facility of the retailer. As used herein, the term “facility computing device” can refer to a cash register, checkout device or self-checkout device. The electronic receipt may include a facility identifier corresponding to the facility and a user identifier provided by the user. The classification of the one or more purchased items can be retrieved from an item database using one or more item identifiers corresponding to the one or more purchased items. In one embodiment, the item identifiers are Universal Product Codes (UPCs) scanned at the point of sale. The tax jurisdiction of the facility may be obtained from a facility database using the facility identifier. Similarly, the tax jurisdiction may be obtained based on the geographical location of the facility. Accordingly, for the classification of each purchased item that is mandated as being taxable by the tax jurisdiction, the itemization of the one or more tax rates applicable to the classification of the purchased item may be obtained by retrieving the one or more tax rates applicable to the classification of the purchased item from a tax database using the jurisdiction. Thereafter, the itemization of the one or more tax rates applicable thereto may be generated and included within the electronic receipt provided to the user.

The generated itemization of the one or more tax rates applicable to each classification of each purchased item may include a tax incurred by the user for each tax rate applicable to the classification of the purchased item. In one embodiment, the tax rate includes a sales tax rate indicative of a non-zero integer applied to a net cost, e.g., retail cost, of the purchased item. In another embodiment, the tax rate includes an excise tax rate indicative of a non-zero integer applied to a unit of the purchased item.

Customers will accordingly be made aware of how legislature imposed by governing bodies effects their monies. In an exemplary embodiment, a hyper link directed to a uniform resource locator (URL) may be generated. The URL can indicate tax information related to the tax jurisdiction of the facility. Tax information may include tax rates applicable to classifications of items imposed by the tax jurisdiction such as sales tax rates and excise tax rates. Additionally, the tax information may include tax rates applicable to classifications of items imposed by one or more principle tax jurisdictions when the tax jurisdiction is a constituent of the principle tax jurisdiction. Furthermore, the tax information may include dates of enactment for tax rates applicable to classifications of items and initiatives and reforms related to tax rates applicable to classifications of purchased items. The hyper link may be included with the electronic receipt provided to the customer.

Retailers are equipped with computing devices to input and view information. As used herein, the term “computing device” can refer to mobile computing devices, such as mobile telephones, laptop computers, and tablet computers, or stationary computing devices. For example, a retailer computing device may input item information corresponding to the item in an item database. The item information, including the net cost to purchase the item and the classification of the item, can be retrieved from the item database using an item identifier corresponding to the item. Furthermore, the retailer computing device may input whether or not the item is taxable or exempt from being taxable as mandated by a tax jurisdiction of the facility. Accordingly, the tax rate can be retrieved from the tax database using the tax jurisdiction of the facility and the classification of the item.

Users are equipped with computing devices to receive information. For example, a user computing device can receive an electronic receipt including the itemization of one or more taxes applicable to each classification of each purchased item that is mandated by the tax jurisdiction as being taxable. For instance, the user may provide a user identifier by swiping a card or entering a user name/password/email at the point of sale such that the electronic receipt can be provided to the user. In one embodiment, the user may receive the electronic receipt via email. In another embodiment, the user may receive an electronic notification on a mobile computing device.

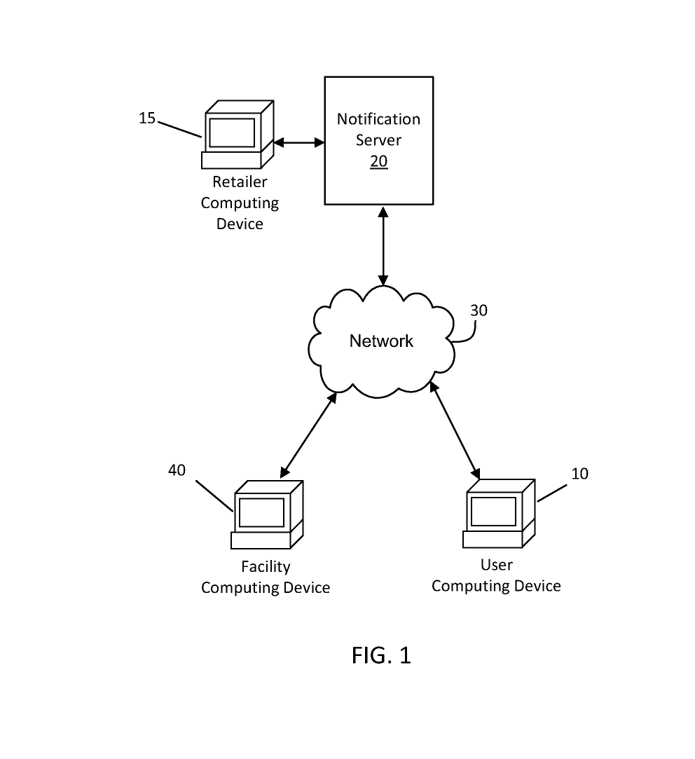

FIG. 1 illustrates a tax itemization server 20 in communication with a facility computing device 40, a user computing device 10. The retailer computing device 15 can include a stationary computing device located at an offsite location. While one retailer computing device 15 is illustrated, the term “retailer computing device” refers to one or more computing devices that operate to transmit one or more inputs to the tax itemization server 20 for inputting into respective databases: item identifiers and tax rates applicable to a plurality of classifications and a plurality of tax jurisdictions. The facility computing device can include a check-out computing device operated by a facility attendant and a self-checkout operated by the user. While one tax itemization server 20 is illustrated, the term “tax itemization server” refers to one or more servers that operate in an individual or distributed manner. For instance, each facility computing device 40 may include a respective “tax itemization server 20” or one “tax itemization server 20” may operate a plurality of facility computing devices 40.

In the illustrated example, the tax itemization server 20 may receive an electronic receipt at a point of sale from the facility computing device 40 furnished within a facility by the retailer via the network 30. As used herein, the term “network” can refer to any communication network including, but not limited to, a wireless network, a cellular network, an intranet, the Internet, or combinations thereof. The electronic receipt is indicative of one or more purchased items, each purchased item indicating a purchased product from the facility of the retailer. The electronic receipt received by the tax itemization server 20 may include a facility identifier corresponding to the facility and a user identifier provided by the user at the point of sale. Thereafter, the tax itemization server 20 may retrieve a classification of the one or more purchased items from an item database using one or more item identifiers (e.g., UPC) corresponding to the one or more purchased items. Embodiments include the classification of each of the one or more purchased items is selected from the group consisting of: groceries, prepared food, prescription medication, non-prescription medication, clothing, agricultural, alcohol/tobacco, soft drinks and generally taxed items. Concurrently, the tax itemization server 20 may retrieve a tax jurisdiction from a facility database using the facility database.

It will be appreciated that the tax jurisdiction includes a governing body encompassing the geographical location of the facility and mandates certain classifications of purchased items as being taxable and certain classifications of purchased items as being exempt from taxation. Specifically, the tax jurisdiction imposes one or more tax rates applicable to the classification of the purchased item when the classification is mandated by the tax jurisdiction as being taxable. Embodiments include the tax jurisdiction of the facility is selected from the group consisting of: a country, a state, a province, a country, a borough and a municipality. In one embodiment, more than one tax rate is applicable to a classification of the purchased item when the tax jurisdiction includes a constituent tax jurisdiction of one or more principle tax jurisdictions. For instance, the constituent tax jurisdiction may include a city within a county of a state, one principle tax jurisdiction may include the country and another principle tax jurisdiction may include the state. Accordingly, each of the constituent tax jurisdiction and the one or more principle tax jurisdictions impose at least one respective tax rate applicable to the classification. Tax rates can include sales tax rates being indicative of a non-zero integer applied to net cost of the purchased item. Similarly, tax rates can include excise tax rates being indicative of a non-zero integer applied to a unit of the purchased item.

Embodiments include a processing device of the tax itemization server 20 retrieving the one or more tax rates applicable to the classification of the purchased item from a tax database using the tax jurisdiction. Thereafter, the processing device of the tax itemization server 20 generates the itemization of the one or more tax rates applicable to the classification of the purchased item based on the one or more retrieved tax rates applicable to the classification. Specifically, the generated itemization includes a tax incurred by the user for each tax rate applicable to each classification of each purchased item mandated as being taxable by the tax jurisdiction. For instance, each applicable sales tax rate is multiplied by a net cost of the purchased item to determine the tax incurred by the user and each applicable excise tax rate is multiplied by a unit of the purchased item to determine the tax incurred by the user.

Embodiments further include the processing device of the tax itemization server 20 generating a hyper link directed to a URL indicating tax information related to the tax jurisdiction of the facility, wherein the electronic receipt provided to the user computing device 10 via the network 30 further includes the hyper link. In one embodiment, the tax information related to the tax jurisdiction includes information indicative of tax rates applicable to classification of items imposed by the tax jurisdiction. For instance, the hyper link may direct the user to a URL corresponding to a tax jurisdiction, wherein the URL lists applicable tax rates according to classifications. In another embodiment the tax information includes information indicative of tax rates applicable to classifications of items imposed by one or more principle tax jurisdictions when the tax jurisdiction comprises a constituent tax jurisdiction of one or more principle tax jurisdictions. For instance, the hyper link may direct the user to a URL corresponding to a retailer, wherein the retailer provides tax specific information relating to tax rates applicable to classifications imposed by a principle jurisdiction, such as a state, in addition to tax rates applicable to classifications imposed by the constituent tax jurisdiction, such as a city within the state. In another embodiment, the tax information includes information indicative of dates of enactment for tax rates applicable to classifications of item. In this embodiment, the user may be made aware of newly enacted legislature imposing adjustments to tax rates and/or new tax rates. In yet another embodiment, the tax information includes information indicative of initiatives and reforms related to tax rates applicable to classifications of items. For instance, the hyper link may direct the user to a URL corresponding to the tax jurisdiction, wherein the tax jurisdiction describes motives for imposing applicable tax rates and how the money obtained from the tax rates will be allocated, e.g., programs the money will be used for.

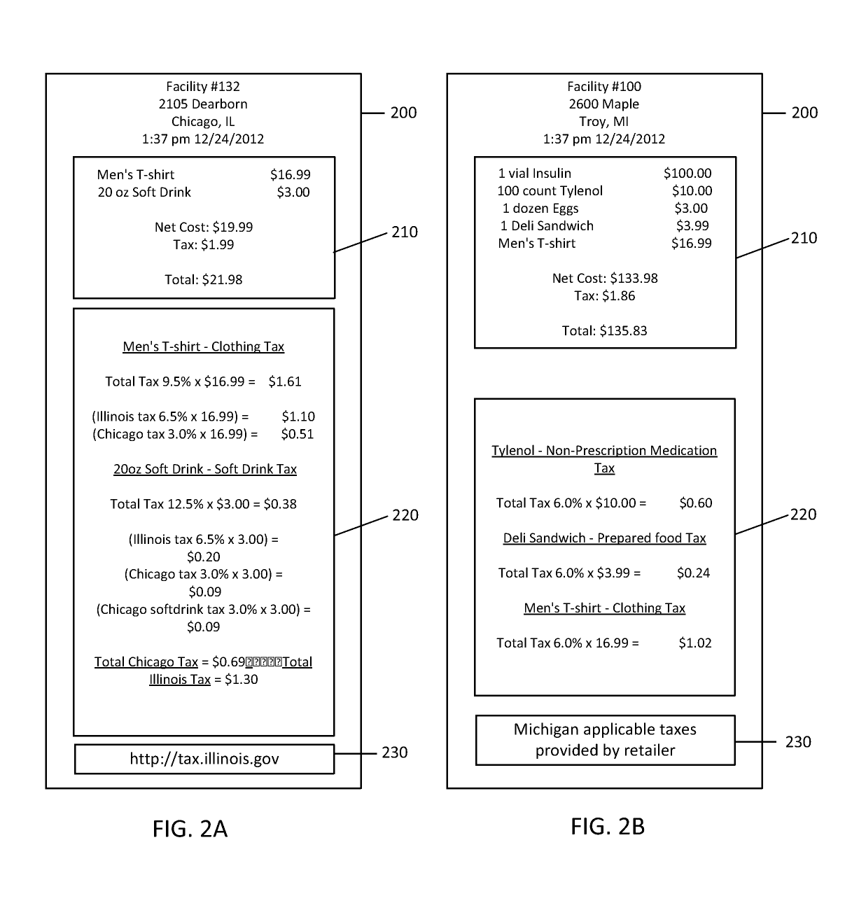

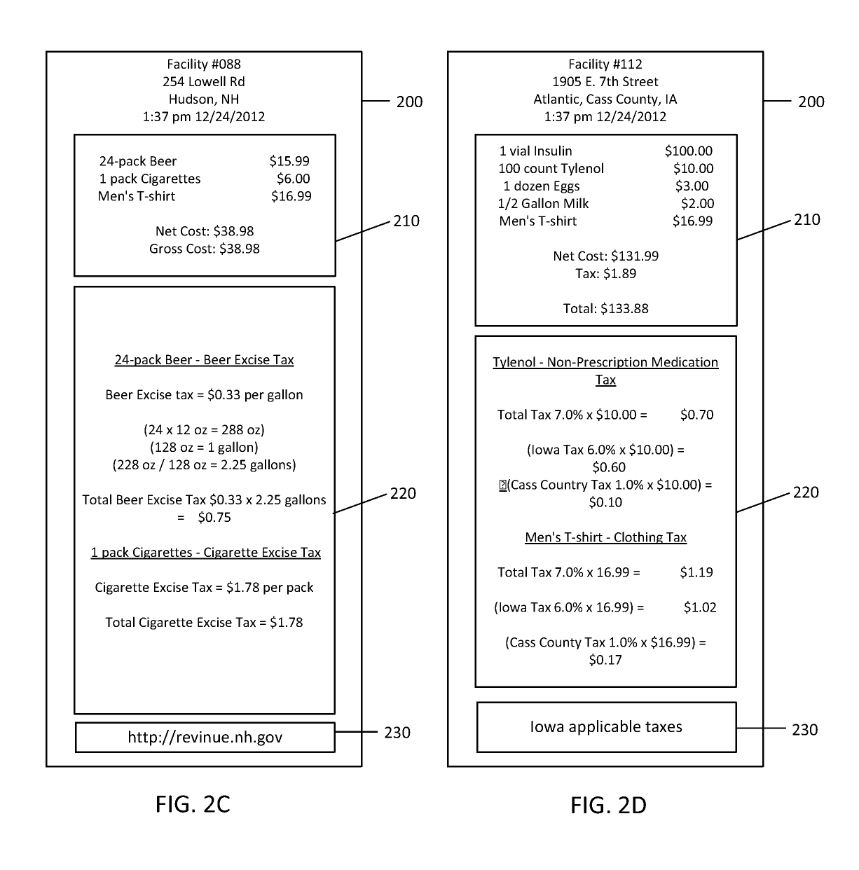

FIGS. 2A-2D schematically illustrate non-limiting examples of electronic receipts including an itemization of one or more tax rates applicable to each classification of each purchased that is mandated by a tax jurisdiction as being taxable, in accordance with the present disclosure. FIGS. 2A-2D schematically illustrate an electronic receipt 200 including a general portion 210 that indicates one or more purchased items, each purchased item indicating a purchased product from a facility of the retailer. The general portion may further include a net cost of all purchased items and a gross cost of all the purchased items. As used herein, the term “gross cost” can refer to an actual or true cost a customer pays at a point of sale to purchase the item including any applicable sales tax rates. The electronic receipt 200 further includes an itemization portion 220 indicating an itemization of one or more tax rates applicable to each classification of each purchased item that is mandated as being taxable by a tax jurisdiction. The electronic receipt 200 may further include a hyper link 230 configured to direct a user to a uniform resource locator (URL) indicating tax information related to the tax jurisdiction of the facility. The electronic receipt 200 further includes a facility identifier and/or a geographical location of the facility used to determine the tax jurisdiction of the facility, the tax jurisdiction having taxation authority to mandate certain classifications of items as being taxable (or as being exempt from taxation). Additionally, each electronic receipt 200 is indicative of a particular date and time of the purchase at the point of sale.

In the illustrated example of FIG. 2A, the general portion 210 of the electronic receipt 200 indicates one or more purchased items corresponding to a men's T-shirt and a 20 oz soft drink purchased from a facility located in Chicago, Ill. Chicago includes a constituent tax jurisdiction of the state of Illinois. Accordingly, Chicago applies a home rule or local sales tax in addition to the principle tax jurisdiction of the state of Illinois's general sales tax for certain classifications of items. The general portion 210 further indicates a net cost, a tax incurred by the user and a gross cost incurred by the user for the purchased items. The t-shirt can be classified as clothing, wherein both Chicago and Illinois mandate clothing as being taxable and each imposing a respective sales tax rate. The soft drink can be classified as prepared food, wherein both Chicago and Illinois mandate prepared food as being taxable and each imposing a respective sales tax rate. Additionally, the City of Chicago applies an additional sales tax rate for the purchase of items classified as soft drinks.

Referring to the itemization portion 220 of FIG. 2A, the itemization of each sales tax rate applicable to each classification of each purchased item mandated as being taxable by Chicago and its principle tax jurisdiction of Illinois is illustrated. For instance, a 6.5% sales tax rate corresponding to Illinois's general sales tax rate and a 3.5% sales tax rate corresponding to Chicago's local sales tax rate are applicable to the men's t-shirt. Likewise, a 6.5% sales tax rate corresponding to Illinois's general sales tax rate, a 3.5% sales tax rate corresponding to Chicago's local sales tax rate and a 3.0% sales tax rate corresponding to Chicago's soft drink sales tax rate is applied to the soft drink. Accordingly, the tax incurred by the user for each tax rate applicable to each classification of each purchased item is calculated by multiplying each sales tax rate applicable to respective classifications by a net cost of each respective purchased item.

In the illustrated example of FIG. 2B, the general portion 210 of the electronic receipt 200 indicates one or more purchased items corresponding to a men's T-shirt, 1 vial of Insulin, 100 count of Tylenol, 1 dozen Eggs and 1 Deli sandwich purchased from a facility located in Troy, Mich. It will be understood that the state of Michigan does not include any constituent tax jurisdictions, and therefore, no home rule or local tax rates in addition to Michigan's general sales tax rate are applicable for the City of Troy. The general portion 210 further indicates a net cost, a tax incurred by the user and a gross cost incurred by the user for the purchased items. The vial of Insulin can be classified as prescription medication, wherein Michigan mandates prescription medications as being exempt from taxation. The 100 count of Tylenol can be classified as non-prescription medication, wherein Michigan mandates non-prescription medication as being taxable and imposes Michigan's general sales tax rate of 6.0%. The 1 dozen eggs can be classified as groceries, wherein Michigan mandates groceries as being exempt from taxation. The Deli sandwich can be classified as prepared food, wherein Michigan mandates prepared food as being taxable and imposes Michigan's sales tax rate of 6.0%. The t-shirt can be classified as clothing, wherein Michigan mandates clothing as being taxable and imposes Michigan's sales tax rate of 6.0%.

Referring to the itemization portion 220 of FIG. 2B, the itemization of each sales tax rate applicable to each classification of each purchased item mandated as being taxable by Michigan is illustrated. The itemization includes a tax incurred by the user for each tax rate applicable to each classification of each purchased item. For instance, Michigan's 6.0% general sales tax rate is applied to each of the Tylenol, the deli sandwich and the men's t-shirt.

In the illustrated example of FIG. 2C, the general portion 210 of the electronic receipt 200 indicates one or more purchased items corresponding to a 24-pack of beer, 1 pack of cigarettes and a men's t-shirt purchased from a facility located in Hudson, N.H. The general portion 210 further indicates a net cost and a gross cost incurred by the user for the purchased items. In the example illustrated, New Hampshire does not include any constituent tax jurisdictions and mandates all classifications of items as being exempt from sales taxation except prepared food. Therefore, New Hampshire does not apply a sales tax rate to the beer, the cigarettes or the t-shirt. However, New Hampshire does mandate an excise tax rate for the purchase of beer and cigarettes. The beer excise tax rate is $0.33 per gallon and the cigarette excise tax rate is $1.78 per pack. As aforementioned, excise tax rates are paid directly by the retailer to the tax jurisdiction and end up being covered by the user/customer through inflation of the net cost of the items having an applicable excise tax rate. Hence, the general tax portion 210 does not reflect the beer and cigarette excise tax rates.

Referring to the itemization portion 220 of FIG. 2C, the itemization of each excise tax rate applicable to each classification of each purchased item mandated as being taxable by New Hampshire is illustrated. The itemization includes a tax incurred by the user for each tax rate applicable to each classification of each purchased item mandated as being taxable. For instance, New Hampshire's $0.33 per gallon beer excise tax rate is applied to the 24-pack of beer and New Hampshire's $1.78 per pack cigarette excise tax rate is applied to the 1 pack of cigarettes. Accordingly, the tax incurred by the user for each tax rate applicable to each classification of each purchased item is calculated by multiplying each excise tax rate applicable to respective classifications by a unit of each purchased item. In the illustrated example, the user incurs or covers an excise tax of $0.75 for the 24-pack of beer and $1.78 for the 1 pack of cigarettes.

In the illustrated example of FIG. 2D, the general portion 210 of the electronic receipt 200 indicates one or more purchased items corresponding to a men's T-shirt, 1 vial of Insulin, 100 count of Tylenol, 1 dozen Eggs and ½ gallon of Milk purchased from a facility located in Atlantic, Cass Country, IA. Cass country includes a constituent tax jurisdiction of the state of Iowa. Accordingly, Cass Country applies a home rule or local sales tax in addition to the principle tax jurisdiction of the state of Iowa's general sales tax for certain classifications of items. The general portion 210 further indicates a net cost, a tax incurred by the user and a gross cost incurred by the user for the purchased items. The vial of Insulin can be classified as prescription medication, wherein both Cass County and the state Iowa mandate prescription medications as being exempt from taxation. The 100 count of Tylenol can be classified as non-prescription medication, wherein both Cass Country and the state of Iowa mandate non-prescription medication as being taxable and each impose a respective sales tax rate. The 1 dozen eggs and the ½ gallon of milk can each be classified as groceries, wherein Cass Country and the state of Iowa mandate groceries as being exempt from taxation. The t-shirt can be classified as clothing, wherein both Cass Country and the state of Iowa mandate clothing as being taxable and each impose a respective sales tax rate.

Referring to the itemization portion 220 of FIG. 2D, the itemization of each sales tax rate applicable to each classification of each purchased item mandated as being taxable by Cass Country and its principle tax jurisdiction of Iowa is illustrated. An aggregate sales tax of 7.0% is applied to the net cost of each purchased item mandated as being taxable. The itemization includes a tax incurred by the user for each tax rate applicable to each classification of each purchased item. For instance, a 6.0% sales tax rate corresponding to Iowa's general sales tax rate and a 1.0% sales tax rate corresponding to Cass County's local sales tax rate are applicable to each of the Tylenol and the men's T-shirt. Accordingly, the tax incurred by the user for each tax rate applicable to each classification of each purchased item is calculated by multiplying each sales tax rate applicable to respective classifications by a net cost of each respective purchased item.

The examples of FIGS. 2A-2D are provided for example only and not intended to be limiting. It will be appreciated that the itemization (i.e., generated itemization) is not limited to any type, but each generated itemization may include any combination of non-zero integers corresponding applicable sales tax rates, non-zero integers corresponding to applicable excise tax rates, an aggregate tax rates incurred by the customer for each classification that is mandated as taxable by a tax jurisdiction, and tax rates applicable to one or both of constituent and principle tax jurisdictions. The tax jurisdiction can be obtained from a facility identifier at the point of sale or a geographical location of the facility encompassed by a governing body that is the tax jurisdiction.

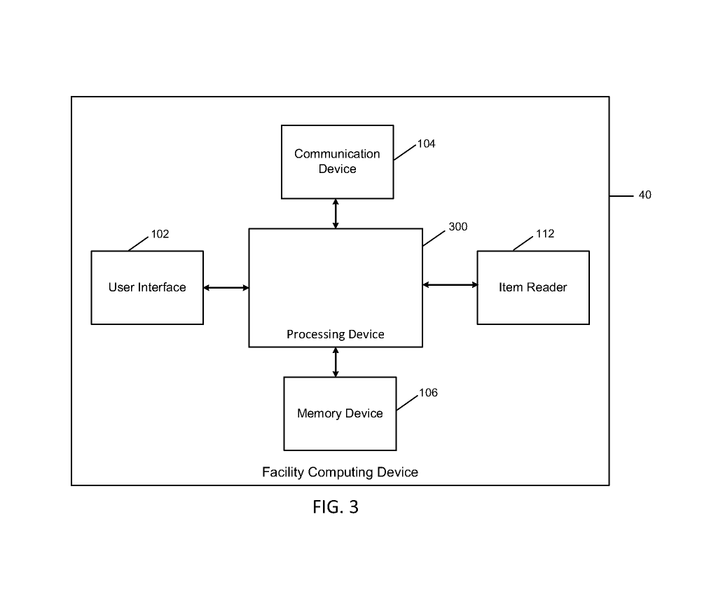

Referring now to FIG. 3 a block diagram illustrating example components of the facility computing device 40 of FIG. 1 is depicted. In an exemplary embodiment, the facility computing device 40 includes a processing device 300, a user interface 102, a communication device 104, a memory device, and an item reader 112.

The processing device 300 can include memory, e.g., read only memory (ROM) and random access memory (RAM), storing processor-executable instructions and one or more processors that execute the processor-executable instructions. In embodiments where the processing device 300 includes two or more processors, the processors can operate in a parallel or distributed manner. The processing device 300 can execute the operating system of the facility computing device 40.

The user interface 102 is a device that allows a user to interact with the computing device 10. The user can correspond to the user purchasing the products when the facility computing device includes a self checkout device or the user can correspond to a facility attendant operating the facility computing device including a checkout device, e.g., cash register. While one user interface 102 is shown, the term “user interface” can include, but is not limited to, a touch screen, a physical keyboard, a mouse, a microphone, and/or a speaker. The communication device 104 is a device that allows the facility computing device 40 to communicate with another device, e.g., the tax itemization server 20, via the network 30. In the exemplary embodiment, the facility computing device 40 is a checkout device at a point of sale within the facility. The communication device 104 can include one or more wireless transceivers for performing wireless communication and/or one or more communication ports for performing wired communication. The memory device 106 is a device that stores data generated by the facility computing device. For instance, the memory device 106 may store electronic receipts for a plurality of transactions conducted through the facility computing device 40. The memory device 106 can include, but is not limited to a hard disc drive, an optical disc drive, and/or a flash memory drive. The item reader 112 can include a scanning device for reading bar codes or quick response (QR) codes to obtain item identifiers (UPCs) of items purchased at the point of sale.

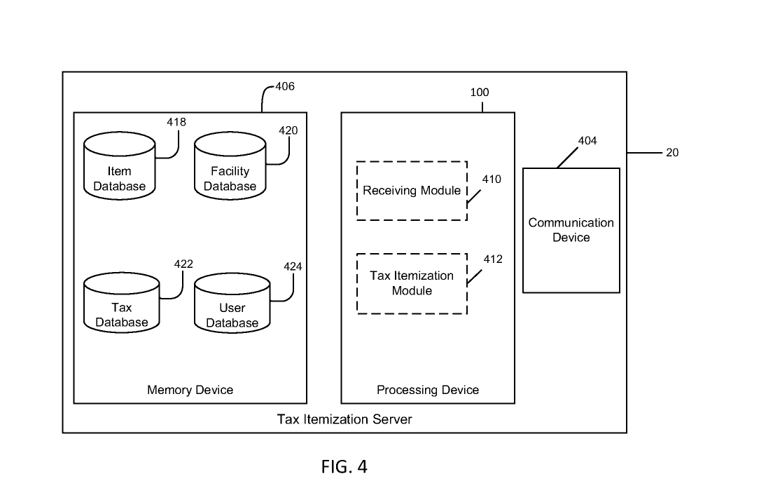

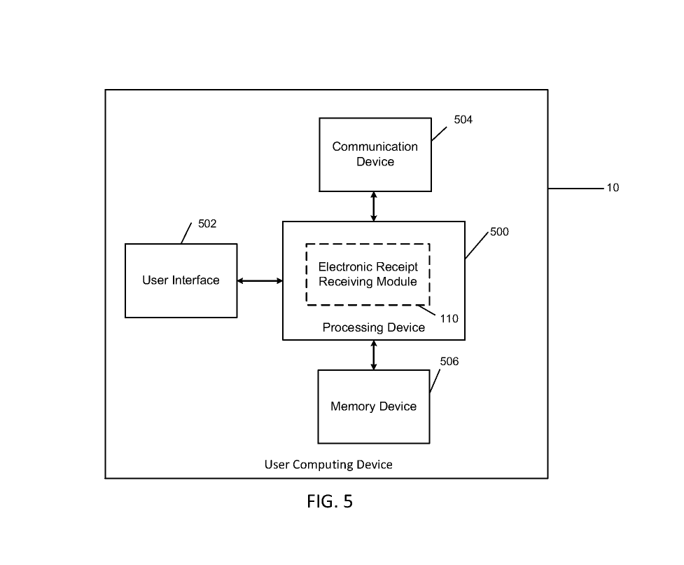

Referring now to FIG. 4, a block diagram illustrating example components of the tax itemization server 20 of FIG. 1 is depicted. In an exemplary embodiment, the tax itemization server 20 includes a processing device 100, a communication device 404, and a memory device 406.

The processing device 100 can include memory, e.g., read only memory (ROM) and random access memory (RAM), storing processor-executable instructions and one or more processors that execute the processor-executable instructions. In embodiments where the processing device 100 includes two or more processors, the processors can operate in a parallel or distributed manner. In the illustrative embodiment, the processing device 401 executes a receiving module 410 and a tax itemization module 412, which are described in greater detail below.

The receiving module 410 can receive an electronic receipt broadcasted from the facility computing device 40 at a point of sale. The electronic receipt may include a facility identifier corresponding to the facility and a user identifier provided by the user. For instance, the user may scan a loyalty card or enter a username/password/email at the point of sale. The user identifier may be stored in a user database 424 and retrieved for providing the electronic receipt to the user. The tax itemization module 412 can thereby extract a classification of each purchased item and a tax jurisdiction of the facility from the electronic receipt. Specifically, the tax itemization module 412 retrieves the classification of the one or more purchased items from an item database 418 using one or more item identifiers corresponding to the one or more purchased items. The item identifiers may be broadcasted from the facility computing device and received by the receiving module 412. The classification of the item is selected from the group consisting of: groceries, prepared food, prescription medication, non-prescription medication, clothing, agricultural, alcohol/tobacco, and generally taxed items. A purchased item classified as alcohol can be further be classified as the type of alcohol, such as beer or spirits, or the content of alcohol. A purchased item classified as tobacco can be further classified as the type of tobacco, such as cigarettes or smokeless tobacco. Likewise, the tax itemization module 412 retrieves the tax jurisdiction of the facility from a facility database 420 using the facility identifier. The tax jurisdiction of the facility is selected from the group consisting of: a country, a state, a province, a county, a borough, and a municipality.

The tax itemization module 412 is further configured to retrieve one or more tax rates applicable to each classification of each purchased item from a tax database 422 using the tax jurisdiction. In one embodiment, when the tax jurisdiction includes a constituent tax jurisdiction of a principle tax jurisdiction, a local tax rate corresponding to the constituent tax jurisdiction can be applied to each classification mandated as being taxable by the constituent tax jurisdiction in addition to a general tax rate corresponding to the principle tax jurisdiction applied to each classification mandated as being taxable by the principle tax jurisdiction. Tax rates can include sales tax rates indicative of a non-zero integer (e.g., percentage) applied to a net cost of the purchased item and excise tax rates indicative of a non-zero integer (e.g., dollar amount) applied to a unit of the purchased item. Thereafter, for the classification of each purchased item mandated as being taxable by the tax jurisdiction, the tax itemization module 412 may generate the itemization of the one or more tax rates applicable to the classification of the purchased item based on the one or more retrieved tax rates applicable to the classification. In one embodiment, the generated itemization includes a tax incurred by the user for each tax rate applicable to the classification of the purchased item. For instance, an applicable sales tax rate is multiplied by a net cost of the purchased item to determine the tax incurred by the user. Likewise, an applicable excise tax rate is multiplied by a unit of the purchased item to determine the tax incurred by the user. Non-limiting example of electronic receipts including a generated itemization of one or more tax rates applicable to each classification of each purchased item mandated as being taxable by the tax jurisdiction are discussed above in the non-limiting examples of FIGS. 2A-2D.

The tax itemization module 412 is further configured to generate a hyper link directed to a uniform resource locator (URL) that is configured to provide tax information related to the tax jurisdiction of the facility. In one embodiment, the tax information related to the tax jurisdiction and provided by the URL is indicative of tax rates applicable to classifications of items imposed by the tax jurisdiction. Similarly, the tax information related to the tax jurisdiction may be indicative of tax rates applicable to classifications of items imposed by one or more principle tax jurisdictions when the tax jurisdiction includes a constituent tax jurisdiction of one or more principle tax jurisdictions. For instance, clothing may have a local sales tax rate imposed by the city of Chicago in addition to a general sales tax rate imposed by Chicago's principle tax jurisdiction of the state of Illinois. Additionally, the tax information related to the jurisdiction provided by the URL may be indicative of dates of enactment for tax rates applicable to classifications of items to allow the user to be aware of new or adjusted existing tax rates. In yet another embodiment, the tax information related to the jurisdiction and provided by the URL may be indicative of initiatives and reforms related to tax rates applicable to classifications of items. For instance, a soft drink sales tax rate imposed by Chicago may be implemented to discourage unhealthy diets as well as using the money obtained from the soft drink sales tax rate to provide healthcare for obesity.

The communication device 404 is a device that allows the tax itemization server 20 to communicate with another device, e.g., the facility computing device 40 and the user computing device 10, via the network 30. The communication device 404 can include one or more wireless transceivers for performing wireless communication and/or one or more communication ports for performing wired communication.

The memory device 406 is a device that stores data generated or received by the tax itemization server 20. The memory device 406 can include, but is not limited to, a hard disc drive, an optical disc drive, and/or flash memory drive. Further, the memory device 406 may be distributed and located at multiple locations. The memory device 406 is accessible to the processing device 400.

An item database 418, or similar structure, can be stored in the memory device 406. In an exemplary embodiment, a retailer maintains the item database 418 to input and store classifications, net costs and units for a plurality of items offered for sale by the retailer. For instance, a facility or regional manager may input classifications, net costs and units for a plurality of items offered for sale by the retailer using the retailer computing device 15 of FIG. 1. The tax itemization module 412 uses each item identifier, e.g., UPC, included with the electronic receipt received by the receiving module 410 to retrieve the classification, the net cost and the unit of each purchased item from the item database 418.

The facility database 420, or similar structure, can be stored in the memory device 406. In an exemplary embodiment, a retailer maintains the facility database 420 to input and store tax jurisdictions for a plurality of facilities of the retailer. For instance, a geographical location of each facility is encompassed by a governing body including the tax jurisdiction having taxation authority to mandate classifications of items as being taxable or as being exempt from taxation. The tax itemization module 412 uses the facility identifier included with the electronic receipt received by the receiving module 410 to retrieve the tax jurisdiction of the facility. In some embodiments, the tax jurisdiction includes a constituent tax jurisdiction of one or more principle tax jurisdictions.

The tax database 422, or similar structure, can be stored in the memory device 406. In an exemplary embodiment, a retailer maintains the tax database 422 to input and store a plurality of tax rates corresponding to a plurality of classifications and tax jurisdictions. For instance, for each of a plurality of classifications of items, a facility attendant can sort whether each classification is mandated as being taxable by the tax jurisdiction or is mandated as being exempt from taxation by the tax jurisdiction. If the tax jurisdiction includes a constituent tax jurisdiction of one or more principle tax jurisdictions, the facility attendant can sort whether each classification is mandated as being taxable by each of the constituent tax jurisdiction and each of the one or more principle tax jurisdictions. Accordingly, the facility attendant can input one or more tax rates applicable to each classification of each purchased item into the tax database 422 using the tax jurisdiction. In embodiments where the tax jurisdiction is a constituent tax jurisdiction of one or more principle tax jurisdictions also mandating a classification as taxable, the facility attendant can input at least one respective tax rate applicable to the classification for each of the constituent tax jurisdiction and the one or more principle tax jurisdictions. As aforementioned, the tax rates may include excise tax rates each being indicative of a non-zero integer (e.g., dollar amount) and sales tax rates each being indicative of a non-zero integer (e.g., percentage). In a non-limiting example, the tax database 422 may be arranged such that one or more classifications and one or more tax jurisdictions are laid out in a two dimensional table, wherein a determination can be made on whether each of the one or more classifications are mandated as being taxable (or exempt from taxation). Accordingly, the tax rate, e.g., non-zero integer corresponding to one of an excise or sales tax rate, applicable to each of the classifications can be retrieved using the tax jurisdiction. Using the retrieved one or more tax rates applicable to the each classification of each purchased item from the tax database 422, the tax itemization module 412 can generate the itemization of the one or more tax rates applicable to each classification of each purchased item. As aforementioned, in one embodiment, the generated itemization may include the tax incurred by the user calculated by multiplying each applicable sales tax rate by a net cost of each purchased item. Likewise, the generated itemization may additionally or alternatively include the tax incurred by the user calculated by multiplying each applicable excise tax rate by a unit of each purchased. Non-limiting examples of generated itemizations of one or more tax rates applicable to each classification of each purchased item mandated as being taxable by the tax jurisdiction are discussed above in the non-limiting examples of FIGS. 2A-2D. The electronic receipt including the generated itemization is thereby transmitted from the tax itemization module 412 using the communication device 404 to the user computing device 10 of FIG. 1. Providing a customer with an electronic receipt that includes the itemization of one or more tax rates applicable to each classification of each purchased item that is mandated as being taxable is beneficial for a customer to quickly determine how items being purchased are being taxed and to whom their taxes are going to.

In another exemplary embodiment, a retailer maintains the tax database 422 to input and store a plurality of hyper links directed to respective uniform resource locators providing tax information related to a plurality of tax jurisdiction. For instance, when one or more tax rates applicable to a classification of a purchased item are retrieved from the tax database 422, a hyper link directed to a URL providing tax information related to the tax jurisdiction can additionally be retrieved from the tax database 422. In one embodiment, the URL is furnished by the tax jurisdiction, e.g., a governing body. In another embodiment, the URL is furnished by the retailer. In yet another embodiment, the URL may be furnished by an information source (e.g., Wikipedia) providing tax information related to a tax jurisdiction. The electronic receipt including the generated itemization and the hyper link is thereby transmitted from the tax itemization module 412 using the communication device 404 to the user computing device 10 of FIG. 1. Providing a customer with an electronic receipt that includes a hyper link directed to a URL providing tax information related to a tax jurisdiction is beneficial for a customer to learn how taxes incurred by the customer are being allocated, when applicable tax rates were enacted by a tax jurisdiction, and be informed of initiatives and reforms of applicable tax rates imposed by a tax jurisdiction.

The user database 424, or similar structure, can be stored in the memory device 406. In an exemplary embodiment, a retailer maintains the user database 424 to input and store a plurality of electronic receipts including generated itemizations and hyper links corresponding to the user. For instance, each electronic receipt may be indicative of a particular date and time of a point of sale. A user may retrieve an electronic receipt including a generated itemization and hyper link corresponding to a particular date and time from the user database 424 using an item identifier, e.g., username/password, and a search query indicative of the particular date and time.

Referring now to FIG. 5, a block diagram illustrating example components of the user computing device 10 of FIG. 1 is depicted. In the example embodiment, the display apparatus 10 includes a processing device 500, a user interface 502, a communications device 504, and a memory device 506.

The processing device can include memory, e.g., read only memory (ROM) and random access memory (RAM), storing processor-executable instructions and one or more processors that execute the processor-executable instructions. In embodiments where the processing device 500 includes two or more processors, the processors can operate in a parallel or distributed manner. The processing device 500 can execute the operating system of the user computing device. In the illustrative embodiment, the processing device 500 also includes a electronic receipt receiving module 110 for receiving an electronic receipt including a generated itemization and a hyper link transmitted from the tax itemization server 20 of FIG. 1.

The user interface 502 is a device that allows a user to interact with the user computing device 10. While one user interface 502 is shown, the term “user interface” can include, but is not limited to, a touch screen, a physical keyboard, a mouse, a microphone, and/or a speaker. For instance, the user interface 502 may be used to view an email and/or notification sent by the tax itemization server 20 that includes an electronic receipt including a generated itemization and a hyper link. The communication device 504 is a device that allows the user computing device 10 to communicate with another device, e.g., the tax itemization server 20, via the network 30. The communication device 504 can include one or more wireless transceivers for performing wireless communication and/or one or more communication ports for performing wired communication. The memory device 506 is a device that stores data generated or received by the user computing device 10. The memory device 506 can include, but is not limited to a hard disc drive, an optical disc drive, and/or a flash memory drive. The memory device 506 can include storage for received electronic receipts each including a generated itemization and hyper link, wherein each electronic receipt is indicative of a particular time and date.

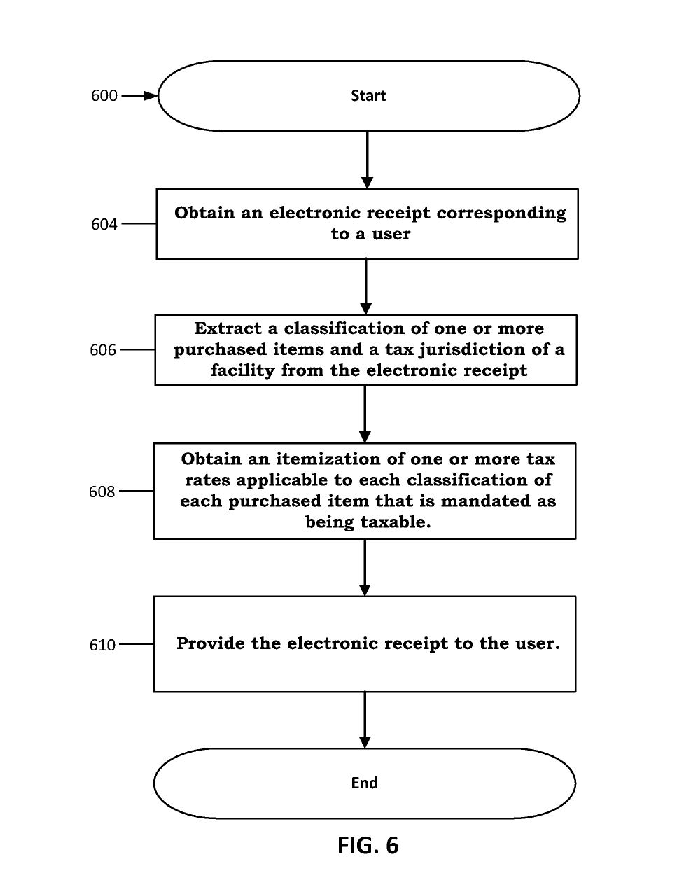

FIG. 6 illustrates an example method of a flowchart 600 that can be executed by the tax itemization server 20 providing an electronic receipt including an itemization of one or more tax rates applicable to each classification of each purchased item that is mandated as being taxable from the tax itemization server 20 to the user computing device 10 corresponding to the user. At operation 604, the tax itemization module 412 obtains an electronic receipt corresponding to a user from the facility computing device 40. The receiving module 412 receives the electronic receipt at a point of sale from the facility computing device furnished within the facility by the retailer. At operation 606, the tax itemization module 412 extracts a classification of one or more purchased items and a tax jurisdiction of the facility from the electronic receipt. Using an item identifier, e.g., UPC, the classification, along with a net cost and a unit of each the one or more purchased items, may be retrieved from the item database 418. As previously mentioned, the classification of the item can include groceries, prepared food, prescription medication, non-prescription medication, clothing, agricultural, alcohol/tobacco, and generally taxed items. Using a facility identifier the tax jurisdiction may be retrieved from the facility database 420. As previously mentioned, the tax jurisdiction of the facility can include a country, a state, a province, a county, a borough, and a municipality.

At operation 608, the tax itemization module 412 obtains an itemization of one or more tax rates applicable to each classification of each purchased item that is mandated as being taxable. As aforementioned, more than one tax rates are applicable to each classification of each purchased item when the tax jurisdiction comprises a constituent tax jurisdiction of one or more principle tax jurisdictions also mandating each classification as taxable, wherein each of the constituent tax jurisdiction and the one or more principle tax jurisdictions impose at least one respective tax rate applicable to each classification mandated as taxable. The tax itemization module 412 can retrieve the one or more tax rates applicable to the classification of the purchased item from the tax database 422 using the tax jurisdiction. The tax itemization module can thereby generate an itemization of applicable tax rates imposed by the tax jurisdiction for each classification that is mandated as being taxable. The generated itemization may include a tax incurred by the user for each tax rate applicable to the each classification of each purchased item. The tax incurred is calculated for applicable excise tax rates by multiplying a non-zero integer (e.g., dollar amount) imposed by the tax jurisdiction by a unit of purchased item. The tax incurred is calculated for applicable sales tax rates by multiplying a non-zero integer (e.g., percentage) imposed by the tax jurisdiction by a net cost of the purchased item. Non-limiting examples of electronic receipts including an itemization of one or more tax rates applicable to each classification of each purchased item mandated as being taxable by a tax jurisdiction are discussed above in the non-limiting examples of FIGS. 2A-2D.

At operation 610, the tax itemization module 412 can transmit the electronic receipt including the generated itemization (and a hyper link) to the user computing device 10. From here, a customer can view the electronic receipt including an itemization of one or more tax rates applicable to each classification of each item purchased by the user. The customer may now be made aware of hidden excise tax rates inflating retail costs of items purchased in addition to a distribution of taxes incurred by the user from both local and general sales tax rates instead of an aggregate tax incurred by the user for a total purchase at a point of sale.

The above description of illustrated examples of the present invention, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A method for providing an electronic receipt to a user, comprising:
obtaining, at a processing device of a tax itemization server, the electronic receipt corresponding to the user, the electronic receipt indicating one or more purchased items, each purchased item indicating a purchased product from a facility of the retailer;
extracting from the electronic receipt:
a. a classification of each of the one or more purchased items, and
b. a tax jurisdiction of the facility, the tax jurisdiction having taxation authority to mandate classifications of purchased items as being taxable;
for the classification of each purchased item that is mandated as being taxable by the tax jurisdiction, obtaining, at the processing device, an itemization of one or more tax rates applicable to the classification of the purchased item that are imposed by the tax jurisdiction; and
providing, at the processing device, the electronic receipt to the user, the electronic receipt including the itemization of one or more tax rates applicable to each classification of each purchased item that is mandated as being taxable.

2. The method of claim 1, wherein more than one tax rates are applicable to the classification of the purchased item when the tax jurisdiction comprises a constituent tax jurisdiction of one or more principle tax jurisdictions also mandating the classification as taxable, each of the constituent tax jurisdiction and the one or more principle tax jurisdictions imposing at least one respective tax rate applicable to the classification.

3. The method of claim 1, wherein the one or more tax rates applicable to the classification of the purchased item include at least one of:
a. one or more sales tax rates each being indicative of a non-zero integer applied to a net cost of the purchased item; and
b. one or more excise tax rates each being indicative of a non-zero integer applied to a unit of the purchased item.

4. The method of claim 1, wherein extracting the classification of the one or more purchased items and the tax jurisdiction of the facility from the electronic receipt comprises:
receiving, at the processing device, the electronic receipt at a point of sale from a facility computing device furnished within the facility by the retailer, the electronic receipt including a facility identifier corresponding to the facility and a user identifier provided by the user, wherein the electronic receipt is provided to the user using the user identifier; and
at the processing device, retrieving:
a. the classification, a net cost and a unit of the one or more purchased items from an item database using one or more item identifiers corresponding to the one or more purchased items, the item database storing classifications, net costs and units for a plurality of items offered for sale by the retailer, and
b. the tax jurisdiction of the facility from a facility database using the facility identifier, the facility database storing tax jurisdictions for a plurality of facilities of the retailer.

5. The method of claim 1, wherein obtaining the itemization of one or more tax rates applicable to the classification of the purchased item that are imposed by the tax jurisdiction comprises:
retrieving, at the processing device, the one or more tax rates applicable to the classification of the purchased item from a tax database using the tax jurisdiction, the tax database storing a plurality of tax rates corresponding to a plurality of classifications and tax jurisdictions;
generating, at the processing device, the itemization of the one or more tax rates applicable to the classification of the purchased item based on the one or more retrieved tax rates applicable to the classification.

6. The method of claim 5, wherein the generated itemization of the one or more taxes applicable to the classification includes:
a tax incurred by the user for each tax rate applicable to the classification of the purchased item, the tax incurred is calculated by at least one of:
a. for each tax rate corresponding to a sales tax rate, multiplying each sales tax rate by a net cost of the purchased item, and
b. for each tax rate corresponding to an excise tax rate, multiplying each excise tax rate by a unit of the purchased item.

7. The method of claim 1, further comprising:
generating, at the processing device, a hyper link directed to a uniform resource locator providing tax information related to the tax jurisdiction of the facility, wherein the electronic receipt provided to the user further includes the hyper link.

8. The method of claim 7, wherein the tax information related to the tax jurisdiction comprises information indicative of at least one of:
a. tax rates applicable to classifications of items imposed by the tax jurisdiction, the tax rates including sales tax rates and excise tax rates;
b. tax rates applicable to classifications of items imposed by one or more principle tax jurisdictions when the tax jurisdiction comprises a constituent tax jurisdiction of one or more principle tax jurisdictions;
c. dates of enactment for tax rates applicable to classifications of items imposed by the tax jurisdiction; and
d. initiatives and reforms related to tax rates applicable to classifications of items imposed by the tax jurisdiction.

9. The method of claim 1, wherein the classification of each of the one or more purchased items is selected from the group consisting of: groceries, prepared food, prescription medication, non-prescription medication, clothing, agricultural, alcohol/tobacco, soft drinks and generally taxed items.

10. The method of claim 1, wherein the tax jurisdiction of the facility is selected from the group consisting of: a country, a state, a province, a county, a borough, and a municipality.

11. An apparatus for providing an electronic receipt to a user, comprising:
a tax itemization module configured to:
a. obtain the electronic receipt corresponding to the user, the electronic receipt indicating one or more purchased items, each purchased item indicating a purchased product from a facility of the retailer;
b. extract from the electronic receipt:
1. a classification of each of the one or more purchased items, and
2. a tax jurisdiction of the facility, the tax jurisdiction having taxation authority to mandate classifications of purchased items as being taxable;
c. obtain, for the classification of each purchased item that is mandated as being taxable by the tax jurisdiction, an itemization of one or more tax rates applicable to the classification of the purchased item that are imposed by the tax jurisdiction; and
d. provide the electronic receipt to the user, the electronic receipt including the itemization of one or more tax rates applicable to each classification of each purchased item that is mandated as being taxable.

12. The apparatus of claim 11, wherein more than one tax rates are applicable to the classification of the purchased item when the tax jurisdiction comprises a constituent tax jurisdiction of one or more principle tax jurisdictions also mandating the classification as taxable, each of the constituent tax jurisdiction and the one or more principle tax jurisdictions imposing at least one respective tax rate applicable to the classification.

13. The apparatus of claim 11, wherein the one or more tax rates applicable to the classification of the purchased item include at least one of:
a. one or more sales tax rates each being indicative of a non-zero integer applied to a net cost of the purchased item; and
b. one or more excise tax rates each being indicative of a non-zero integer applied to a unit of the purchased item.

14. The apparatus of claim 11, wherein the tax itemization module extracts the classification of the one or more purchased items and the tax jurisdiction of the facility from the electronic receipt by:
receiving the electronic receipt at a receiving module at a point of sale from a facility computing device furnished within the facility by the retailer, the electronic receipt including a facility identifier corresponding to the facility and a user identifier provided by the user, wherein the electronic receipt is provided to the user using the user identifier; and
retrieving:
a. the classification, a net cost and a unit of the one or more purchased items from an item database using one or more item identifiers corresponding to the one or more purchased items, the item database storing classifications, net costs and units for a plurality of items offered for sale by the retailer, and
b. the tax jurisdiction of the facility from a facility database using the facility identifier, the facility database storing tax jurisdictions for a plurality of facilities of the retailer.

15. The apparatus of claim 11, wherein the tax itemization module obtains the itemization of one or more tax rates by:
retrieving the one or more tax rates applicable to the classification of the purchased item from a tax database using the tax jurisdiction, the tax database storing a plurality of tax rates corresponding to a plurality of classifications and tax jurisdictions;
generating the itemization of the one or more tax rates applicable to the classification of the purchased item based on the one or more retrieved tax rates applicable to the classification.

16. The apparatus of claim 15, wherein the generated itemization of the one or more taxes applicable to the classification includes:
a tax incurred by the user for each tax rate applicable to the classification of the purchased item, the tax incurred is calculated by at least one of:
a. for each tax rate corresponding to a sales tax rate, multiplying each sales tax rate by a net cost of the purchased item, and
b. for each tax rate corresponding to an excise tax rate, multiplying each excise tax rate by a unit of the purchased item.

17. The apparatus of claim 1, wherein the tax itemization module is further configured to:
generate a hyper link directed to a uniform resource locator providing tax information related to the tax jurisdiction of the facility, wherein the electronic receipt provided to the user further includes the hyper link.

18. The apparatus of claim 1, wherein the tax information related to the tax jurisdiction comprises information indicative of at least one of:
a. tax rates applicable to classifications of items imposed by the tax jurisdiction;
b. tax rates applicable to classifications of items imposed by one or more principle tax jurisdictions when the tax jurisdiction comprises a constituent tax jurisdiction of the one or more principle tax jurisdictions;
c. dates of enactment for tax rates applicable to classifications of items imposed by the tax jurisdiction; and
d. initiatives and reforms related to tax rates applicable to classifications of items imposed by the tax jurisdiction.

19. The apparatus of claim 1, wherein the classification of each of the one or more purchased items is selected from the group consisting of: groceries, prepared food, prescription medication, non-prescription medication, clothing, agricultural, alcohol/tobacco, soft drinks and generally taxed items.

20. The apparatus of claim 1, wherein the tax jurisdiction of the facility is selected from the group consisting of: a country, a state, a province, a county, a borough, and a municipality.
